(19) United States
(12) Patent Application Publication
(10) Pub. No.: US 2015/0138591 A1
(43) Pub. Date: May 21, 2015

(54) METHOD FOR CUSTOMIZABLE USER SPECIFIED ORDER FOR PRINTING PERSONALIZED ASSESSMENTS

(71) Applicant: Xerox Corporation, Norwalk, CT (US)

(72) Inventors: Mary Ann Sprague, Macedon, NY (US); Maryann Fuhrmann, Webster, NY (US)

(73) Assignee: Xerox Corporation, Norwalk, CT (US)

(21) Appl. No.: 14/082,458

(22) Filed: Nov. 18, 2013

(51) Int. Cl. G06F 3/12; G09B 1/00

(52) U.S. Cl. CPC G06F 3/1263; G06F 3/1253; G09B 1/00
USPC 358/1.15

(57) ABSTRACT

A system and method for customizing assessment print order when using an educator support system that generates personalized documents. The system/method includes generating a plurality of personalized documents to be printed, each document including a recipient identifier indicating a unique recipient to which the document will be distributed after printing, associating a position identifier with each recipient identifier, and arranging the plurality of personalized documents in a specified print order based in part on at least one of the position identifiers associated with each recipient identifier.

### BACKGROUND

Ignite™ Educator Support System is a system developed by Xerox Corporation that enables teachers or other individuals to administer personalized student assessments that are then auto scored and teacher-validated. The assessments are preserved electronically along with metadata from each student. Ignite™ also provides customizable reports on student or class assessment results.

Teachers using the Ignite™ System select and print personalized assessments for each student. Each assessment includes information specific to an individual student and, therefore, each assessment must be distributed to a particular student. Currently, assessments are printed in alphabetical order by student name. However, students are not often seated in alphabetical order in class. As a result, teachers need additional time to distribute the pre-labeled assessments to the correct students. For example, the “take one and pass it back” method of distribution generally cannot be used unless the assessments are pre-sorted manually by the teacher. While minimal in a single instance, the additional distribution time can significantly reduce classroom instruction time over the course of a school year.

### INCORPORATION BY REFERENCE

The following reference, the disclosure of which is incorporated herein in its entirety by reference, is mentioned:

U.S. Patent Application Publication No. 2010/0075290 filed on Mar. 25, 2010.

### BRIEF DESCRIPTION

The present disclosure sets forth an improved system and method for assessment print order when using an educator support system such as Ignite™. The method enables teachers to set user preferences, so personalized assessments and/or other documents are printed in the desired order for any class. The method is defined by the user (e.g. a teacher) and specific to a class or group of students. Each class would have its own print order, that can be saved in the system for reuse. The default print order can then be set to any of the available print orders previously defined according to teacher and class. In one embodiment, the print order is at least in part a function of a physical seating arrangement of a given class.

In accordance with one aspect, a method for customizing a user specified print order for printing personalized assessments comprises generating a plurality of personalized documents to be printed, each document including a recipient identifier indicating a unique recipient to which the document will be distributed after printing, associating a position identifier with each recipient identifier, and arranging the plurality of personalized documents in a specified print order based at least in part on at least one of the position identifiers associated with each recipient identifier.

The method can further comprise printing the personalized documents in the specified print order. The generating of the plurality of personalized documents can include using an educator support system. The position identifier can include at least one of a relative location, a row, a column, or a table number. The method can further comprise providing at least one layout template including at least one position identifier. The layout template can include a plurality of position identifiers, each position identifier corresponding to a physical seat location within a classroom. The position identifiers can be arranged in at least one of a matrix, an arc, a u-shape, or a circle. The method can further comprise displaying the recipient identifiers on a display, arranging the recipient identifiers in a desired print order on the display, wherein associating a position identifier with each recipient identifier is based on the recipient identifier locations relative to each other on the display. The arranging can include using a drag-and-drop feature. The method can also include storing the specified print order in the memory of a computer.

In accordance with another method, a system for customizing a user specified print order for printing personalized assessments comprises a data processing device, a processor-usable medium embodying computer code, said processor-usable medium being coupled to said data processing device, said computer code comprising instructions executable by said processor and configured for: generating a plurality of personalized documents to be printed, each document including a recipient identifier indicating a unique recipient to which the document will be distributed after printing, associating a position identifier with each recipient identifier, and arranging the plurality of personalized documents in a specified print order based at least in part on at least one of the position identifiers associated with each recipient identifier.

The system can further comprise a printer. The instructions can further comprise printing the personalized documents in the specified print order using the printer. The position identifier can include at least one of a relative location, a row, a column, or a table number. The instructions can further comprise providing at least one layout template including at least one position identifier, said layout template being stored in processor-usable medium. The layout template can include a plurality of position identifiers, each position identifier corresponding to a physical seat location within a classroom. The position identifiers can be arranged in at least one of a matrix, an arc, a u-shape, or a circle. The system can further include a display and a user input device, and the instructions can include displaying the recipient identifiers on a display, and receiving input from the user input device for arranging the recipient identifiers in a desired print order on the display, wherein the associating a position identifier with each recipient identifier is based on the recipient identifier locations relative to each other on the display. The instructions can include instructions for presenting a drag-and-drop functionality on the display. The instructions can further include storing the specified print order in a memory, and/or using the specific print order as a default print order.

### BRIEF DESCRIPTION OF THE DRAWINGS

FIG. 1 is a pictorial diagram of an exemplary method flow in accordance with the present disclosure;

FIG. 2 is a diagram of the general configuration of system architecture of an exemplary educator support system;

FIG. 3 a flow chart of an exemplary method in accordance with the present disclosure;

FIG. 4 is a block diagram of an exemplary system in accordance with the present disclosure;

FIG. 5 is a screenshot of an exemplary print order module in accordance with the present disclosure;

FIG. 6 is a screenshot of the exemplary print order module of FIG. 5 after arranging names in a desired configuration;

FIG. 7 is a screenshot of another exemplary print order module illustrating another configuration; and

FIG. 8 is a screenshot of another exemplary print order module illustrating still another configuration.

### DETAILED DESCRIPTION

An educator support system is a system for automatically evaluating assessments of the type given by a teacher/educator for determining the state of learning or progress of students during the course of instructions. These systems are applicable particularly in a classroom setting where the teacher is responsible for educating a relatively large group of students. In one exemplary system commercially referred to as Ignite™, a teacher/educator can select from a digital user interface (DUI) of a Multifunction Device (MFD) any of multiple predetermined stored assessment forms in a Data Warehouse/Repository of such assessment forms for administration to a teacher/educator selected group of one or more students.

The teacher then requests the system to create an Assessment Batch and to print out personalized versions of the assessment form, where each version is automatically bar coded for the individual student. The student's name is also printed on the form for the purpose of delivering each assessment to the appropriate student. If desired, the student's name may be printed on the reverse side of the form such as, for example in large print, such that the person administering the test can verify from a distance that each student has the correct form, and so that forms can be handed out individually without disclosing the content of the assessment.

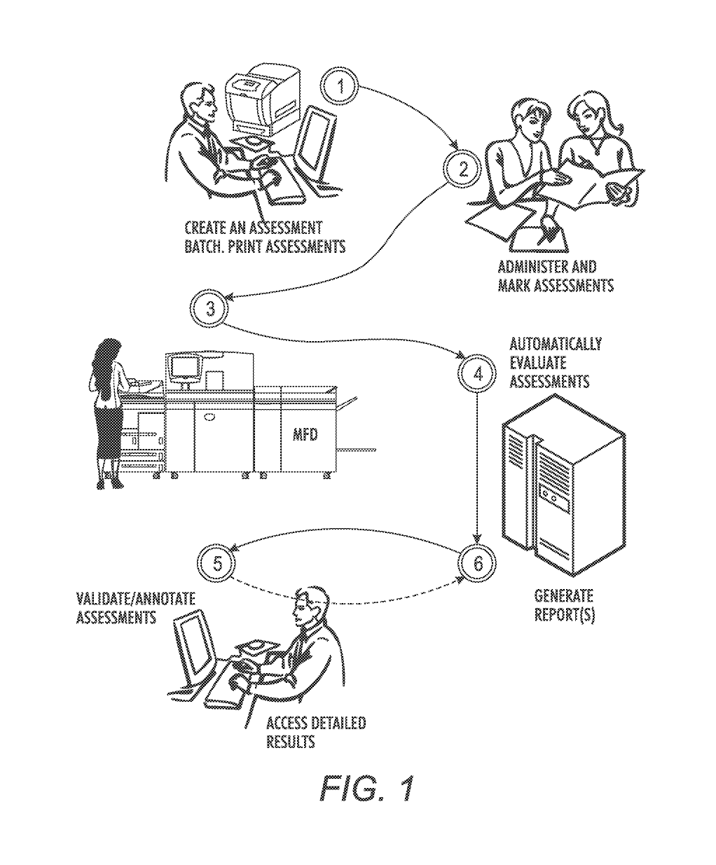

Referring to FIG. 1, an overview of the functional operation of an educator support system is illustrated wherein at a teacher/educator accesses the educator support system using a personal computer (desktop, laptop, or other device) to input the information required regarding the assessment form and student or number of students desired to create an Assessment Batch; and, once the Assessment Batch has been created in the system by teacher/educator, the assessments may be also printed at a local or remote printer. In the present practice, an Assessment Batch includes the teacher's name and a student list which includes the names of the students to be included in the batch, the particular assessment form to be administered to the students in the student list and the creation date of the Assessment Batch. Although in this example the assessments can be created using a personal computer, it will be appreciated that the assessments or other documents can be created using any suitable interface (personal computer, tablet, etc.) with access to the web-based user interface.

At station 2 of the system indicated generally at 10 in FIG. 1, the teacher/educator administers the assessments which are marked. Depending on the type of the assessment, the printed sheets may be marked by the teacher/educator or the students according to the nature of the assessment.

At station 3, the teacher/educator or their designated representative, scans the marked assessments into the system at the MFD. At station 4, the system automatically evaluates the assessments employing image analysis according to the established rubrics associated with the assessment form associated with the Assessment Batch and enables the teacher to access the evaluations at station 5 which is illustrated as a remote station such as a teacher's personal computer (PC). The teacher/educator validates/annotates the assessments and upon receipt of the validation, the system generates reports at station 6 which may be accessed and viewed at either the MFD or the teacher's personal computer terminal remote from the MFD.

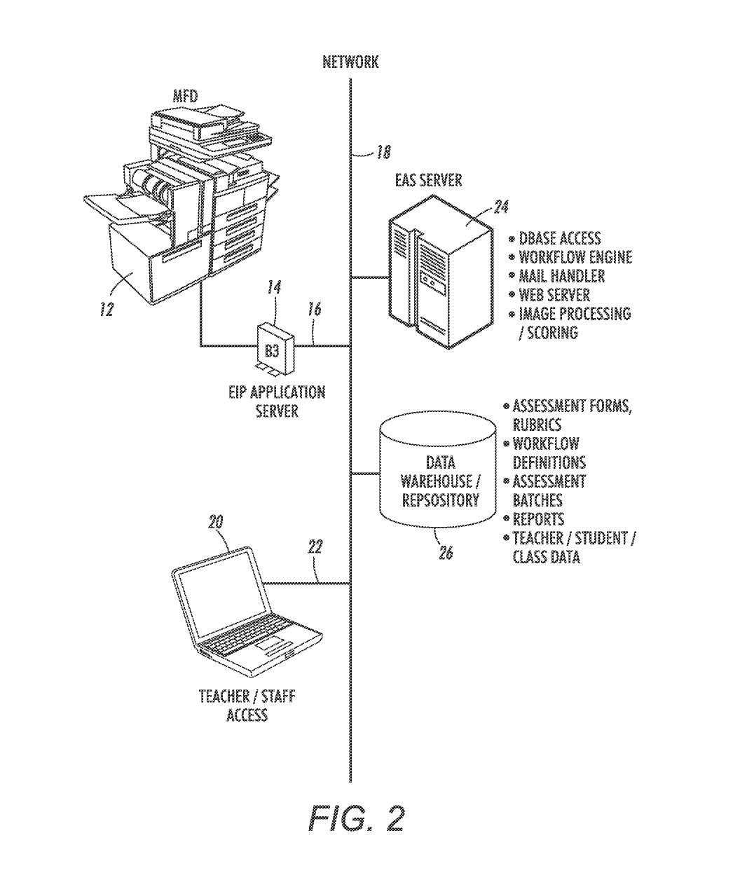

Referring to FIG. 2, the overall architecture of the system is illustrated pictorially with the MFD 12 connected through an application server 14 along line 16 to a network 18 which may be either a local or wide area network and may include connections to the internet. A remote terminal or PC 20 such as a teacher/educator access terminal is connected along line 22 to the network 18. A system server 24 is also connected to the network 18 and provides the functions of database access, serves as a workflow engine, mail handler, web server and functions of image processing/scoring.

A Data Warehouse/Repository 26 is also connected to the network and contains such items as assessment forms and associated rubrics, workflow definitions, Assessment Batch records, reports and teacher/student/class data and is operable to receive updates and to provide for access to data stored therein remotely there from over network 18.

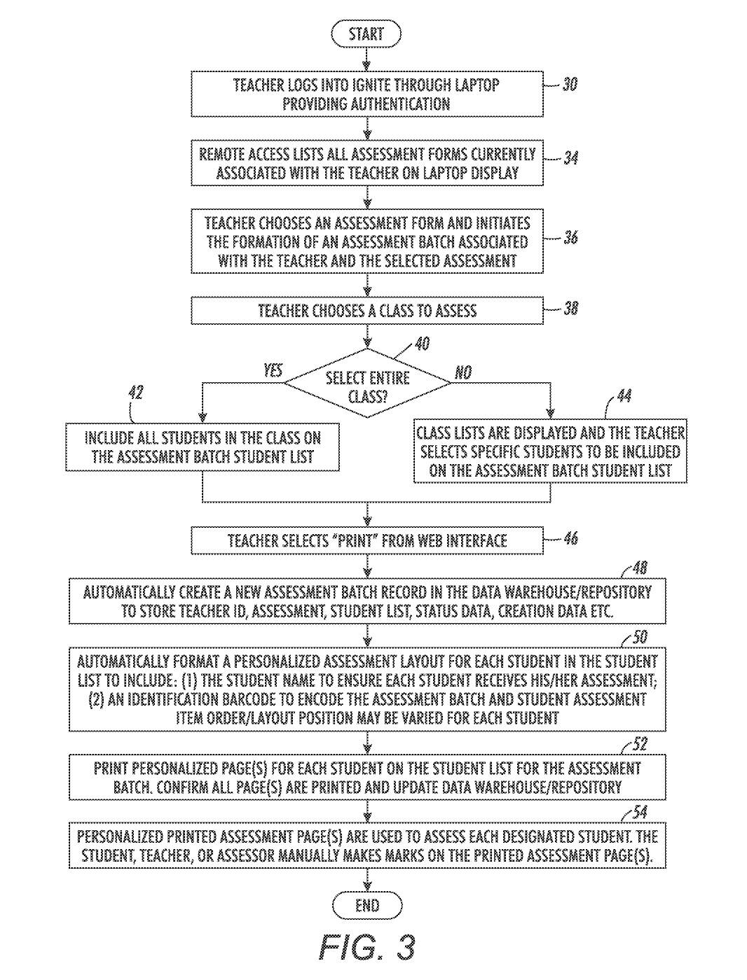

Turning to FIG. 3, the operation of the system is presented in a flow chart in which, at step 30 the teacher/educator logs in to the education assessment service (EAS) print service from the web UI (web-based User Display) of the service 12 and proceeds to provide authentication or personal identification information. At step 34 the system then proceeds to display on the web UI all the pre-defined assessment forms currently associated with the teacher's identification entered in at step 30.

The teacher then chooses at step 36 an assessment form and initiates the formation of an assessment “Batch” associated with that teacher and the selected assessment form. It will be understood, that once initiated, the “Assessment Batch” comprises the basic evaluation unit or cell that the teacher has requested. The teacher then proceeds at step 38 to input a class to assess such as, for example, a seventh grade class, a seventh grade math class, a fifth grade English writing class, or a fourth grade reading class, etc. The system then proceeds to step 40 and enquires as to whether the teacher/educator wishes to select the entire class; and, if the enquiry in step 40 is answered in the affirmative, the system then proceeds to step 42 and includes all selected students in the class on the Assessment Batch Student List. However, if the query at step 40 is answered in the negative, the system proceeds to step 44 and the class list is displayed on the Web UI and the teacher selects specific students to be included on the Assessment Batch Student List.

From step 42 or step 44 the system then proceeds to step 46 and the teacher is prompted to select print from the web DUI. The system then proceeds to step 48 and automatically creates a new Assessment Batch record in the Data Warehouse/Repository to store the teacher's identification, the particular assessment form, the Student List, the status data, the date created, and other data which may be required by the particular school administrator/system.

The system then proceeds to step 50 and automatically formats a personalized assessment layout for each student on the Student List, which includes the student name to insure each student receives the correct assessment and an identification bar code to encode the Assessment Batch and the student. The assessment item order/layout for each student may be varied for each student to discourage students from looking at neighboring students' assessments for hints. The system then proceeds to step 52, prints the personalized page(s) for each student on the Student List for the Assessment Batch. The system then confirms that all page(s) are printed and updates the Data Warehouse/Repository.

At step 54, the teacher/educator takes the personalized printed assessment page(s) and administers the assessment to each designated student. The teacher/assessor or student, as the case may be, manually marks on the printed assessment page(s) the appropriate response to the challenge indicated on the particular assessment page. Upon completion of marking of the assessments, the marked assessment pages are collected by the teacher/educator for subsequent evaluation.

Additional details of the exemplary system 10 are set forth in U.S. Patent Application Publication No. 2010/0075290 filed on Mar. 25, 2010, which is incorporated herein by reference in its entirety. It will be appreciated that the exemplary system 10 is illustrative of but one type of system to which the present disclosure pertains.

In accordance with the present disclosure, a print order customization feature includes a set of user setting options offered to the teacher/educator to define the print order for a selected assessment. The print order would specify the order in which the personalized student assessments are printed in step 52 of the method illustrated in FIG. 3.

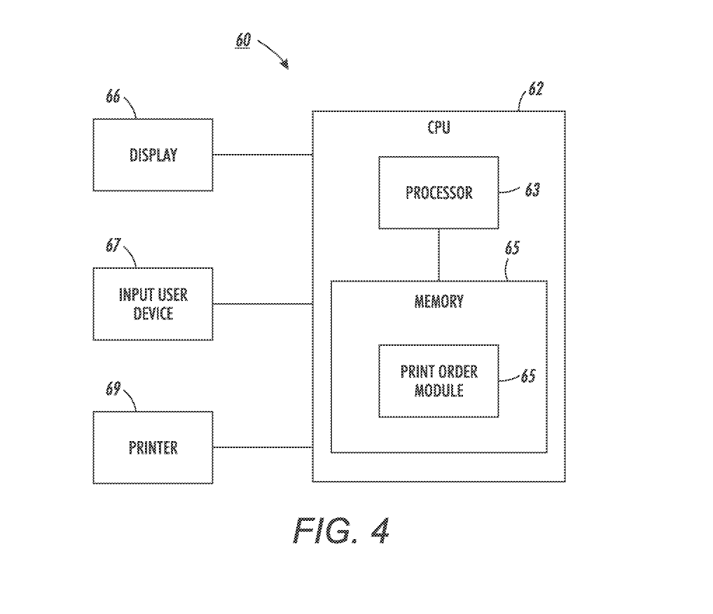

Referring to FIG. 4, an exemplary system 60 in accordance with the present disclosure comprises a data processing device in the form of CPU 62. CPU 62 can be, for example, a processing unit of the MFD 12 previously described. CPU 62 includes a processor 63 coupled with a memory 64. Stored within the memory 64 is a print order customization module 65 comprising instructions for carrying out various ordering features as will be described below. The system 60 also includes a display 66 and a user input device 67. The display 66 and user input device 67 enable a user, such as a teacher/educator, to arrange/rearrange a print order. A printer 69 is provided for printing the documents once a print order is set.

In operation, it will be appreciated that a plurality of personalized documents are generated in any suitable manner (e.g., as described above). An initial default print order is established and can be, for example, alphabetical by student last name. However, as noted above, this print order in many instances is less than ideal. Accordingly, the print order customization module offers a variety of print orders that can be selected by the teacher/educator to simplify distribution of the printed assessments. In general, the print order customization module facilitates association of a recipient identifier (e.g., student name) of each personalized document with a position identifier (e.g., location within the classroom) such that the print order of the documents can be based at least in part on the physical seating arrangements of the recipients of the personalized documents.

For example, the students within a given classroom can be separated into rows and columns in accordance with the seating layout of the classroom. Then, the assessments can be printed alphabetically by student name within each of the rows or columns. This print option allows the teacher/educator to specify the number of rows or columns in the classroom and then assessments can be printed alphabetically by separating the class or group into the specified number of rows/columns. An option for a separator sheet to be generated between rows/columns allows the teacher/educator to easily determine the beginning and end of each subset of students within the stack of printed assessments. An example of this is illustrated in the table below wherein students are assigned to respective columns:

Front of Class

| Column 1 | Column 2 | Column 3 | Column 4 |
|---|---|---|---|
| Jack | Buddy | Laura | Ellen |
| Sam | Carmen | Mark | William |
| Surath | | | |

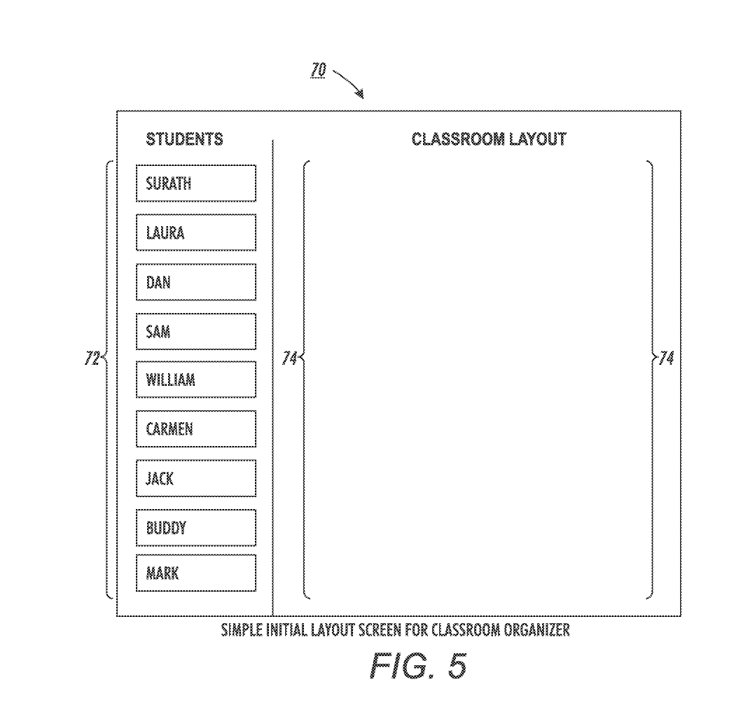

In another example, a customizable classroom print order is generated using the familiar drag-and-drop functionality wherein a name is selected and “dragged” to a different position on a display and “dropped” at the new location. This option can be implemented as a button or option that initiates a print order customization module that generates a popup window (or other visual representation) displaying to the teacher/educator a sample classroom setup along with a list of student names. In FIG. 5, a screenshot 70 of an exemplary customization module is illustrated wherein a list 72 of students is displayed along with a classroom layout space 74. The list of students represents recipient identifiers, each document being associated with one student. In another embodiment, the student names can be provided in a dropdown list. The teacher/educator can then order students based on the physical layout of the classroom by dragging and dropping the student names into a desired arrangement, thereby specifying a physical seating arrangement of a classroom. The order of the printed assessments can be customized based on the arrangement (e.g., left to right, front to back, alphabetical by row/column, etc.), thereby associating each recipient identifier with a position identifier.

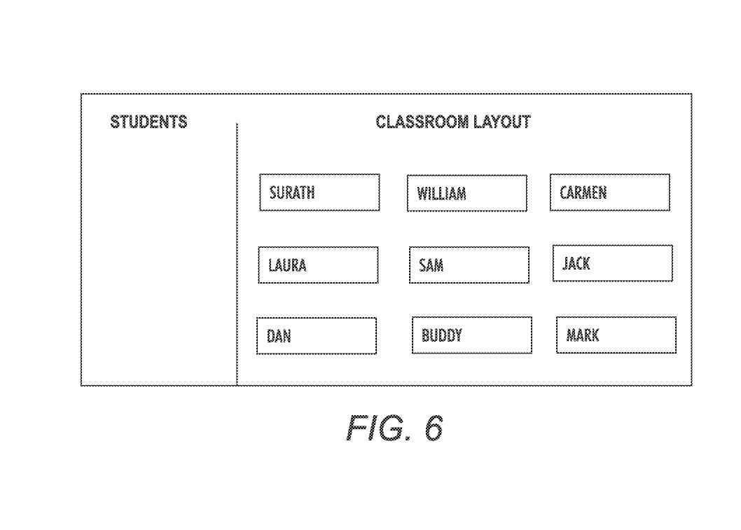

For example, as shown in FIG. 6, each student name can be dragged from the list 72 to a position within the classroom layout space 74. This allows the teacher/educator to quickly and easily arrange the student names in a similar manner to a physical seating arrangement of the students in the classroom. In FIG. 6, the corresponding physical seating arrangement can be individual desks arranged in rows and columns.

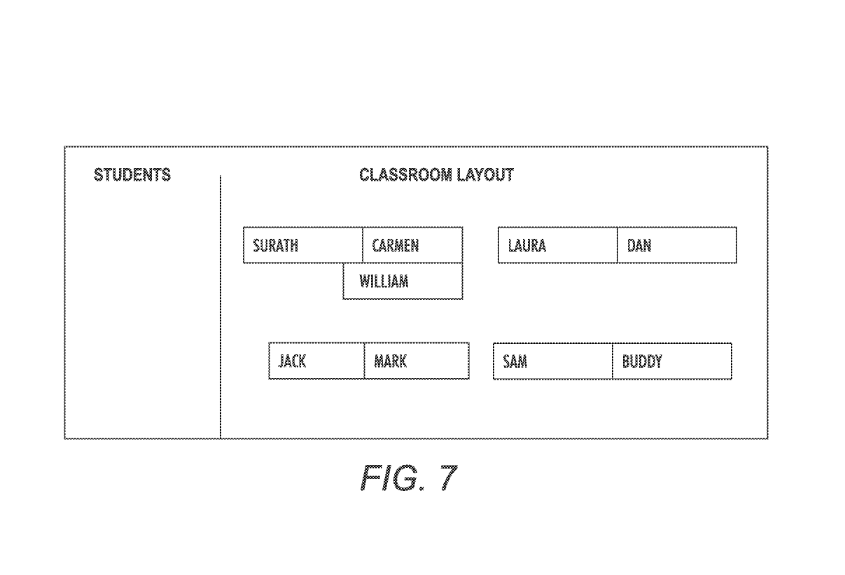

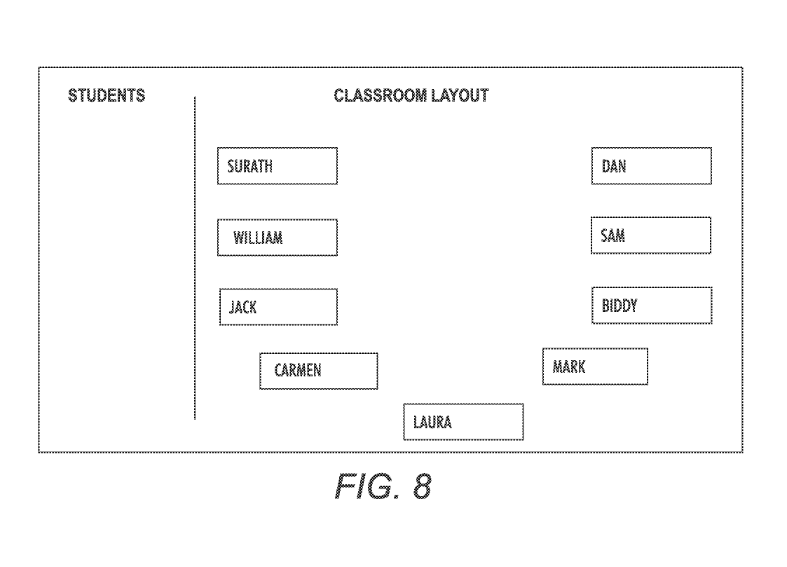

Other physical seating arrangements are also possible and the present disclosure is adaptable to virtually any physical seating arrangement. For example, in FIG. 7 the student names are shown in groups of two or three, corresponding to a physical seating arrangement having clusters of desks (or individual tables at which two or more students are seated). FIG. 8 illustrates another physical seating arrangement. In this instance, the students are seated in a single arcuate line.

Once the custom print order is set, it can be saved for that class or group and user or teacher for future use. Another option is to allow the teacher to specify a print order as the default for future assessment printing. In such case, once the personalized documents are generated, each document is automatically associated with a position identifier based on the previously saved print order. Accordingly, the saved customized print order could be specified as the default print order for future print jobs.

It will be appreciated that the present disclosure provides a method for inputting the physical seating arrangements of a wide range of classrooms. In addition, a variety of pre-existing classroom layouts (templates) can be provided and a teacher/educator can select a layout that resembles the actual classroom layout and populate the layout with student names from the list. For example, various classroom templates can include a single semi-circular row, multiple semi-circular rows, u-shape, circle, etc. The system can be configured to scale the templates to accommodate the number of students in the list of students. Teachers/educators can also number the rows, columns or student groups to specify the order in which the groupings will be printed to further improve the rate of personalized assessment distribution.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A method for customizing a user specified print order for printing personalized assessments to be physically distributed to a plurality of recipients comprising:
generating a plurality of personalized documents to be printed, each document including a recipient identifier indicating a unique recipient to which the document will be distributed after printing;
associating a position identifier with each recipient identifier; and
arranging the plurality of personalized documents in a specified print order based in part on at least one of the position identifiers associated with each recipient identifier;
wherein each of the plurality of personalized documents is an assessment having a plurality of assessment items, and assessments having position identifiers corresponding to adjacent physical locations have a different respective assessment item order/layout.

2. The method of claim 1, further comprising printing the personalized documents in the specified print order.

3. The method of claim 1, wherein the generating the plurality of personalized documents includes using an educator support system.

4. The method of claim 1, wherein the position identifier includes at least one of a relative location, a row, a column, or a table number.

5. The method of claim 1, further comprising providing at least one layout template including at least one position identifier.

6. The method of claim 5, wherein the layout template includes a plurality of position identifiers, each position identifier corresponding to a physical seat location within a classroom.

7. The method of claim 6, wherein position identifiers are arranged in at least one of a matrix, an arc, a u-shape, or a circle.

8. The method of claim 1, further comprising displaying the recipient identifiers on a display, arranging the recipient identifiers in a desired print order on the display, wherein the associating a position identifier with each recipient identifier is based on the recipient identifier locations relative to each other on the display.

9. The method of claim 8, wherein the arranging includes using a drag-and-drop feature.

10. The method of claim 1, further comprising storing the specified print order in a memory of a computer.

11. A system for customizing a user specified print order for printing personalized assessments comprising:
a data processing device;
a processor-usable medium embodying computer code, said processor-usable medium being coupled to said data processing device, said computer code comprising instructions executable by said processor and configured for:
generating a plurality of personalized documents to be printed, each document including a recipient identifier indicating a unique recipient to which the document will be distributed after printing;
associating a position identifier with each recipient identifier; and
arranging the plurality of personalized documents in a specified print order based in part on at least one of the position identifiers associated with each recipient identifier;
wherein each of the plurality of personalized documents is an assessment having a plurality of assessment items, and assessments having position identifiers corresponding to adjacent physical locations have a different respective assessment item order/layout.

12. The system of claim 11, further comprising a printer, wherein the instructions further comprise printing the personalized documents in the specified print order using the printer.

13. The system of claim 11, wherein the position identifier includes at least one of a relative location, a row, a column, or a table number.

14. The system of 11, wherein the instructions further comprise providing at least one layout template including at least one position identifier, said layout template being stored in processor-usable medium.

15. The system of claim 14, wherein the layout template includes a plurality of position identifiers, each position identifier corresponding to a physical seat location within a classroom.

16. The system claim 15, wherein position identifiers are arranged in at least one of a matrix, an arc, a u-shape, or a circle.

17. The system of claim 11, wherein the system further comprises a display, and the instructions include displaying the recipient identifiers on a display, and receiving input from a user input device for arranging the recipient identifiers in a desired print order on the display, wherein associating a position identifier with each recipient identifier is based on the recipient identifier locations relative to each other on the display.

18. The system of claim 17, wherein the instructions include instructions for presenting a drag-and-drop functionality on the display.

19. The system of claim 11, wherein the instructions further comprise storing the specified print order in a memory.

20. The system of claim 19, wherein the instructions further comprise using the specific print order as a default print order.
